(19) United States
(12) Patent Application Publication
(10) Pub. No.: US 2024/0198212 A1
(43) Pub. Date: Jun. 20, 2024

(54) METHOD FOR ATTACKING TARGET IN GAME AND ELECTRONIC DEVICE

(71) Applicant: NETEASE (HANGZHOU) NETWORK CO., LTD., Hangzhou, Zhejiang (CN)

(72) Inventors: Guang LI, Hangzhou, Zhejiang (CN); Chao LIU, Hangzhou, Zhejiang (CN); Qiao HE, Hangzhou, Zhejiang (CN)

(73) Assignee: NETEASE (HANGZHOU) NETWORK CO., LTD., Hangzhou, Zhejiang (CN)

(21) Appl. No.: 18/555,879

(22) PCT Filed: Feb. 24, 2022
(86) PCT No.: PCT/CN2022/077571

§ 371 Date: Oct. 18, 2023

(30) Foreign Application Priority Data
Apr. 19, 2021 (CN) 202110422528.8

(51) Int. Cl. A63F 13/2145; A63F 13/5378; A63F 13/55; A63F 13/822

(52) U.S. Cl. CPC A63F 13/2145; A63F 13/5378; A63F 13/55; A63F 13/822

(57) ABSTRACT

A method for attacking a target in a game and an electronic device are provided, the method includes: in response to a movement operation for the first virtual object, controlling the first virtual object to move in a first virtual scene, and controlling a range of the first virtual scene displayed in the graphical user interface to change correspondingly according to a movement of the first virtual object; and controlling a temporary virtual object in the first virtual scene to move from an initial position to a position where a target virtual object is located and to perform a specified operation on the target virtual object, such that the target virtual object enters a target state.

### CROSS-REFERENCE TO RELATED APPLICATIONS

The present disclosure is the U.S. National Phase Application of PCT Application No. PCT/CN2022/077571, filed on Feb. 24, 2022, which is based on and claims priority to Chinese Patent Application No. 202110422528.8, filed on Apr. 19, 2021, entitled “TARGET ATTACK METHOD AND APPARATUS IN GAME, AND ELECTRONIC DEVICE”, the entire content of both of which are incorporated herein by reference for all purposes.

### TECHNICAL FIELD

The present disclosure relates to a field of game technology; and more particularly, to a method and an apparatus for attacking a target in a game and an electronic device.

### BACKGROUND

In a reasoning game, the game usually include an action session and a voting session. In the related art, in the action session, a virtual object with a first identity may kill other virtual objects, for example, a virtual object with a second identity; and in the voting session, virtual objects in a survival state may participate in a discussion and vote to select a virtual object who may be the first identity.

It should be noted that information disclosed above is merely configured to enhance understanding of BACKGROUND of the present disclosure, which may include information that does not constitute a prior art known to those skilled in the related art.

### SUMMARY

The embodiments of the present disclosure provide a method and an apparatus for attacking a target in a game and an electronic device, so as to help a virtual object to reduce a risk of exposing a target identity and improve a success rate of the attack.

In some aspects, embodiments of the present disclosure provide a method for attacking a target in a game, where a graphical user interface is provided through a terminal device; the graphical user interface includes at least a part of a game scene, a first virtual object with a target identity and a plurality of second virtual objects in a survival state, the plurality of second virtual objects are other virtual objects in a same match with the first virtual object, and the method includes: in response to a movement operation for the first virtual object, controlling the first virtual object to move in a first virtual scene, and controlling a range of the first virtual scene displayed in the graphical user interface to change correspondingly according to a movement of the first virtual object; controlling a temporary virtual object in the first virtual scene to move from an initial position to a position where a target virtual object is located and to perform a specified operation on the target virtual object, such that the target virtual object enters a target state, where the temporary virtual object is a virtual object controlled by the first virtual object with the target identity, and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object.

In some aspects, embodiments of the present disclosure further provide a method for attacking a target in a game, where a graphical user interface is provided through a terminal device; the graphical user interface includes at least a part of a game scene, a first virtual object with a target identity and a plurality of second virtual objects in a survival state, the plurality of second virtual objects are other virtual objects in a same match with the first virtual object, and the method includes: in response to a movement operation for a target virtual object in the second virtual objects, controlling the target virtual object to move in a first virtual scene, and controlling a range of the first virtual scene displayed in the graphical user interface to change correspondingly according to a movement of the target virtual object; in response to that the target virtual object is performed with a specified operation by a temporary virtual object, controlling the target virtual object to enter a target state; where the temporary virtual object is a virtual object controlled by the first virtual object with the target identity; and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object.

In some aspects, embodiments of the present disclosure provide an electronic device, including a processor and a memory, where the memory stores with a machine-executable instruction capable of being executed by the processor, and the processor executes the machine-executable instruction to implement the above method for attacking the target in the game.

It should be understood that the foregoing general descriptions and the following detailed descriptions are exemplary and explanatory only, and are not intended to limit the present disclosure.

### BRIEF DESCRIPTION OF THE DRAWINGS

FIG. 1 is a schematic diagram of an implementation environment provided by some embodiments of the present disclosure;

FIG. 2 is a flowchart of a method for attacking a target in a game provided by some embodiments of the present disclosure;

FIG. 3 is a schematic diagram of a first virtual scene provided by some embodiments of the present disclosure;

FIG. 4 is a schematic diagram of a second virtual scene provided by some embodiments of the present disclosure;

FIG. 5 is a schematic diagram of a display window provided by some embodiments of the present disclosure;

FIG. 6 is another flowchart of a method for attacking a target in a game provided by some embodiments of the present disclosure;

FIG. 7 is a schematic diagram of a virtual scene provided by some embodiments of the present disclosure;

FIG. 8 is a schematic diagram of another virtual scene provided by some embodiments of the present disclosure;

FIG. 9 is a schematic diagram of another virtual scene provided by some embodiments of the present disclosure;

FIG. 10 is a schematic diagram of a game operation function provided by some embodiments of the present disclosure;

FIG. 11 is a structural diagram of an apparatus for attacking a target in a game provided by some embodiments of the present disclosure;

FIG. 12 is a structural diagram of another apparatus for attacking a target in a game provided by some embodiments of the present disclosure;

FIG. 13 is a schematic diagram of an electronic device provided by some embodiments of the present disclosure.

### DETAILED DESCRIPTION

In order to make objectives, technical solutions and advantages of embodiments of the present disclosure more clear, the technical solutions will be described below in a clear and complete manner in conjunction with the accompanying drawings in the embodiments of the present disclosure. It is apparent that the described embodiments are only a part of the embodiments of the present disclosure, and not all of the embodiments. Based on the embodiments of the present disclosure, each other embodiment obtained by a person skilled in the art without paying creative labor falls within the scope of protection of the present disclosure.

First, terms involved in the present disclosure are introduced.

### (1) Virtual Scene

The virtual scene is a virtual scene displayed (or provided) when an application is running on a terminal or server. In some embodiments of the present disclosure, the virtual scene is a simulation environment for the real world, or a semi-simulated and semi-fictional virtual environment, or a pure fictional virtual environment. The virtual scene is any one of two-dimensional virtual scene and three-dimensional virtual scene. The virtual environment may be the sky, land, sea, and the like, where the land includes deserts, cities and other environmental elements. The virtual scene is a scene of a complete game logic of a virtual object controlled by the user.

### (2) Virtual Object

The virtual object refers to a dynamic object that may be controlled in the virtual scene. In some embodiments of the present disclosure, the dynamic object may be a virtual character, a virtual animal, an animated character, and so on. The virtual object is a character controlled by a game player through an input device, or an artificial intelligence (AI) that has been trained to battle in a virtual environment, or a non-player character (NPC) that has been set up to battle in a virtual scene. In some embodiments of the present disclosure, the virtual object is a virtual character competing in a virtual scene. In some embodiments of the present disclosure, the number of virtual objects in the battle of the virtual scene may be preset or may be dynamically determined according to the number of clients participating in the battle, which is not limited by embodiments of the present disclosure. In an implementation of the present disclosure, the user may control the movement of the virtual object in the virtual scene, such as running, jumping, crawling, and the like, and may also control the virtual object to use a skill, a virtual prop, and the like, provided by the application to fight with other virtual objects.

### (3) Player Character

The player character refers to a virtual object that may be controlled by the game player to move around in the game environment. In some video games, it may also be called a god character (or Shikigami character) or hero character. The player character may be at least one of the different forms such as a virtual character, a virtual animal, an animated character, a virtual vehicle, and the like

### (4) Game Interface

The game interface refers to an interface corresponding to an application provided or displayed through a graphical user interface, which includes a game screen and an UI interface for interaction between game players. In some embodiments of the present disclosure, the UI interface may include game controls (e.g., skill controls, movement controls, function controls, and the like), indication identifiers (e.g., direction indication identifiers, character indication identifiers, and the like), information display areas (e.g., the number of kills, a competition time, and the like), or game setting controls (e.g., system settings, stores, coins, and the like). In some embodiments of the present disclosure, the game screen is a display screen corresponding to the virtual scene displayed by the terminal device, and the game screen may include virtual objects such as game characters, NPC characters, AI characters, and so on, which perform the game logic in the virtual scene.

For ease of understanding, the game scenario applicable to the present embodiment is described first. In a match game, a plurality of virtual objects participate, and each user corresponds to one virtual object. The plurality of virtual objects may be divided into two types, first virtual objects with a target identity and other virtual objects without the target identity. The first virtual objects have the target identity, and the target identity enables the first virtual objects to have a specific authority, such as an authority to attack other virtual objects. The first virtual objects know that each other has the target identity, while other virtual objects that do not have the target identity do not know which virtual objects have the target identity and which virtual objects do not have the target identity. The first virtual object attacks other virtual objects, and the virtual objects usually vote among themselves to find out the first virtual object with the target identity.

In a first virtual scene, each virtual object may move freely and perform a specific task. The first virtual object may find out a target virtual object from a plurality of virtual objects, and then attack the target virtual object. The target virtual object that is attacked is usually in a dead state and no longer participates in a subsequent game process of a current match game. The first virtual scene corresponds to an action session in the game.

All the virtual objects in a survival state may be triggered to enter a second virtual scene. For example, if a certain virtual object discovers a target virtual object that has already been attacked, the virtual object may be triggered to enter the second virtual scene, or if a certain virtual object discovers some clues that are conducive to discovering a first virtual object from the virtual objects. In the second virtual scene, all the virtual objects in the survival state start to discuss and vote with the aim of identifying a first virtual object with a target identity from the plurality of virtual objects. The virtual object that receives the most votes is set to be in a dead state and no longer participates in a subsequent game process of a current match game.

If all other virtual objects that do not have the target identity are attacked and killed by the first virtual object, the game is over: or if all the first virtual objects are found, the game is over.

In the above game scenarios, the first virtual object with the target identity needs to move near a certain virtual object, and then perform an attack operation to attack the virtual object to death, which is a cumbersome attack operation with a low success rate, and is prone to exposing his/her own identity in this kind of game, thus affecting the game performance.

Based on the above, some of the present disclosure provide a method and an apparatus for attacking a target in a game, and an electronic device. This technology may be applied to the above game scenarios, or the game scenarios of other reasoning games.

In some embodiments of the present disclosure, the method for attacking the target in the game may be run on a local terminal device or a server. When the method for attacking the target is run on the server, the method may be implemented and executed based on a cloud interaction system, and the cloud interaction system includes a server and a client device.

In some embodiments of the present disclosure, various cloud applications, such as cloud gaming, may be run under the cloud interaction system. Taking the cloud gaming as an example, the cloud gaming refers to a game mode based on cloud computing. In a running mode of the cloud gaming, a main body of running the game program and a main body of presenting a game screen are separated, and the storage and running of a method for attacking the target in the game are completed on the cloud game server, while a function of the client device is receiving and sending data and presenting the game screen. For example, the client device may be a display device with data transmission function close to a user side, such as a mobile terminal, TV, computer, personal digital assistant (PDA), and the like, but the information processing is carried out by the cloud game server in the cloud. When playing the game, the game player operates the client device to send operation instructions to the cloud game server, and the cloud game server runs the game according to the operation instructions, encodes and compresses the game screen and other data, and returns them to the client device through the network, and finally the client device decodes and outputs the game screen.

In some embodiments of the present disclosure, taking a game as an example, a local terminal device stores a game program and is set to present a game screen. The local terminal device is set to interact with the game player via a graphical user interface, i.e., the game program is routinely downloaded, installed, and run via an electronic device. The local terminal device provides the graphical user interface to the game player in a variety of ways, e.g., the graphical user interface may be rendered and displayed on a display screen of the terminal, or may be provided to the game player via holographic projection. For example, the local terminal device may include a display screen and a processor. The display screen is configured to present the graphical user interface that includes the game screen, and the processor is configured to run the game, generate the graphical user interface, and control the display of the graphical user interface on the display screen.

In a possible implementation, some embodiments of the present disclosure provide a method for attacking a target in a game, where a graphical user interface is provided through a terminal device. The terminal device may be the above local terminal device, or the above client device in the cloud interaction system. The terminal device is provided with the graphical user interface, which includes at least a part of the game scene, the first virtual object with the target identity and a plurality of second virtual objects in a survival state. The plurality of second virtual objects are other virtual objects in a same match with the first virtual object. As described in the previous embodiments, the first virtual object with the target identity has the authority to attack other virtual objects, and the virtual objects that are attacked enter a dead state and no longer participate in the subsequent game process. The target identity is an identity attribute assigned at the beginning of the match. For example, among the plurality of virtual objects participating in the game match, a specified number of virtual objects are randomly selected as the first virtual object with the target identity. The other virtual objects that are not selected serve as virtual objects with another identify.

As shown in FIG. 1, a schematic diagram of an implementation environment is provided in some embodiments of the present disclosure. The implementation environment may include; a first terminal device, a game server, and a second terminal device. The first terminal device and the second terminal device communicate with the server respectively to implement data communication. In this implementation, the first terminal device and the second terminal device are each installed with a client that executes the method for attacking the target in the game provided by the present disclosure, and the game server is a server that executes the method for attacking the target in the game provided by the present disclosure. Through the client, the first terminal device and the second terminal device may respectively communicate with the game server.

Taking the first terminal device as an example, the first terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, and the like. When the first terminal device receives a response from the server.

a virtual scene corresponding to the game match is displayed through a graphical user interface of the first terminal device. In an implementation of the present disclosure, the server determines, based on the game request of the client, a target game match for the client from a plurality of game matches that have been established. When the first terminal device receives the response from the server, the virtual scene corresponding to the game match is displayed through the graphical user interface of the first terminal device. The first terminal device is a device controlled by a first user. A virtual object displayed in the graphical user interface of the first terminal device is a player character controlled by the first user. The first user inputs an operation instruction through the graphical user interface to control the player character to perform a corresponding operation in the virtual scene.

Taking the second terminal device as an example, the second terminal device establishes communication with the game server by running the client. In an implementation of the present disclosure, the server establishes a game match according to a game request of the client. A parameter of the game match may be determined based on a parameter in the received game request. For example, the parameter of the game match may include the number of persons participating in the game match, a level of a character participating in the game match, and the like. When the second terminal device receives a response from the server, a virtual scene corresponding to the game match is displayed through a graphical user interface of the second terminal device. In an implementation of the present disclosure, the server determines, based on the game request of the client, a target game match for the client from a plurality of game matches that have been established. When the second terminal device receives the response from the server, the virtual scene corresponding to the game match is displayed through the graphical user interface of the second terminal device. The second terminal device is a device controlled by a second user. A virtual object displayed in the graphical user interface of the second terminal device is a player character controlled by the second user. The second user inputs an operation instruction through the graphical user interface to control the player character to perform a corresponding operation in the virtual scene.

The server performs data calculation based on the received game data reported by the first terminal device and the second terminal device, and synchronizes the calculated game data to the first terminal device and the second terminal device, such that the first terminal device and the second terminal device control the rendering of the corresponding virtual scenes and/or virtual objects in the graphical user interfaces according to the synchronization data sent by the server.

In some embodiments of the present disclosure, the virtual object controlled by the first terminal device and the virtual object controlled by the second terminal device are virtual objects in the same game match. The virtual object controlled by the first terminal device and the virtual object controlled by the second terminal device may have the same character attributes, or may have different character attributes.

It should be noted that the virtual objects in the current game match may include two or more than two virtual objects, and different virtual objects may correspond to different terminal devices, respectively. That is, there are more than two terminal devices in the current game match that respectively send and synchronize the game data with the game server.

In the related art, when the virtual object controlled by the player is in a first identity; the player needs to control the virtual object to move near a certain virtual object, and then perform the attack operation to attack the virtual object to death, which is a cumbersome attack operation with a low success rate, and is prone to exposing his/her own identity in this kind of game, thus affecting the game performance.

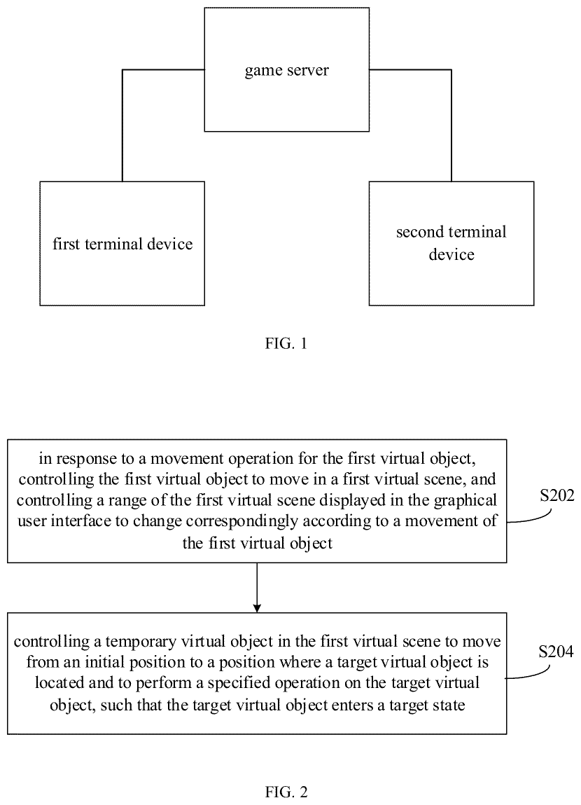

As shown in FIG. 2, the method for attacking a target in a game includes the following steps S202 and S204:
in step S202, in response to a movement operation on the first virtual object, the first virtual object is controlled to move in a first virtual scene, and a range of the first virtual scene displayed in the graphical user interface is controlled to change correspondingly according to a movement of the first virtual object;

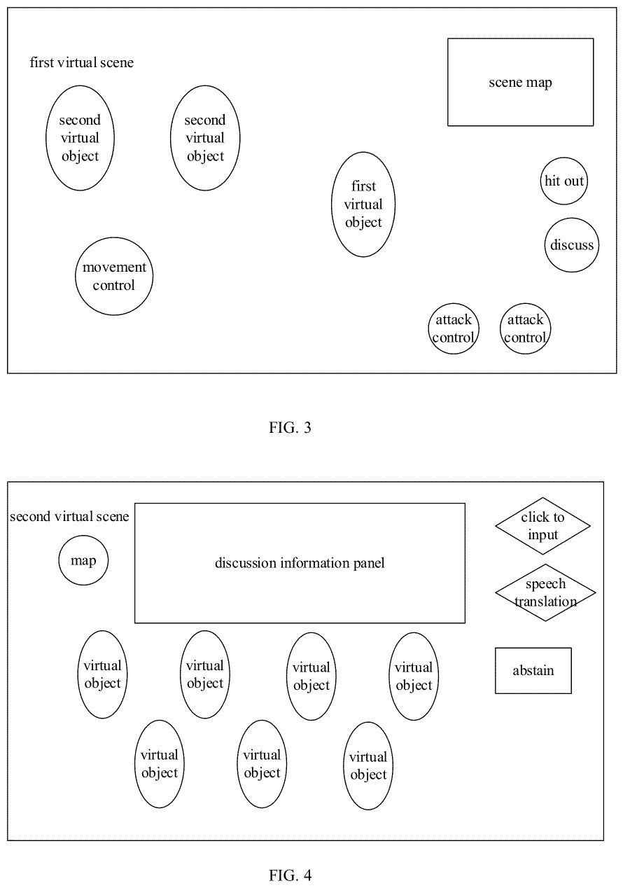

In this embodiment, it is described from the perspective of the first virtual object with the target identity. The first virtual scene is first provided in the graphical user interface, as shown in FIG. 3. In the first virtual scene, the virtual object may move, perform a game task or perform other interactive operation. The user triggers a movement operation for the first virtual object to control the movement of the first virtual object in the first virtual scene, and in most cases, the first virtual object is located in a position at a relative center of the range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the above movement of the first virtual object, if the first virtual object is closer to the other virtual objects, there may be other virtual objects entering into the range of the first virtual scene displayed in the graphical user interface, which are characters controlled by the other players. As shown in FIG. 3, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

In step S204, a temporary virtual object is controlled to move from an initial position to a position where the target virtual object is located in the first virtual scene and a specified operation is performed on the target virtual object, such that the target virtual object enters a target state.

The temporary virtual object is a virtual object controlled by the first virtual object with the target identity, and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object.

In the initial state, the temporary virtual object is not controlled by the user, but under certain specific conditions, the first virtual object with the target identity itself or the user corresponding to the first virtual object with the target identity has the authority to control the temporary virtual object. Specifically, the temporary virtual object may be controlled to move from the initial position to a position where the target virtual object is located in the first virtual scene, and to perform a specified operation on the target virtual object. The initial position may be a position where the temporary virtual object is located when it is not controlled. The specified operation may be an attack operation that produces, after the specified operation is performed on the target virtual object, a specific effect on the target virtual object. i.e., the above-described “make the target virtual object to enter a target state”.

When the user controls the first virtual object to move in the first virtual scene, the user may determine the target virtual object from a plurality of second virtual objects in a survival state. The plurality of second virtual objects in the survival state may refer to the virtual objects in the survival state other than the first virtual object in the current game match. Specifically, the user may determine the target virtual object based on the position, behavior, and the like, of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters the target state.

The second virtual scene is displayed in the graphical user interface upon the triggering of the preset trigger event. For example, the trigger event may be a specific trigger operation, which may be performed by any virtual object in the survival state. For example, in FIG. 3, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, and the like, of the virtual object.

In the second virtual scene, the virtual object in the survival state has the authority to speak, discuss and vote, but the target virtual object enters the target state, resulting in at least some of the interactions configured for the target virtual object in the second virtual scene being in a restricted state. The interactions may include speaking, discussing and voting interactions, and the like. The restricted state may be that a certain interaction is not allowed, or a certain interaction is not allowed within a certain period of time, or a certain interaction is limited to a specified number of times.

As shown in FIG. 4, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. The user may also click on an abstain button to give up the voting authority for this time.

In the above method for attacking the target in the game, in the first virtual scene, the first virtual object with the target identity may control the temporary virtual object to perform the specified operation on the target virtual object, without controlling the first virtual object to directly perform the specified operation on the target virtual object, and the attack manner is easy to operate, which may help the first virtual object to reduce a risk of exposing the target identity; and to improve a success rate of the attack.

In a specific implementation, in response to the preset trigger event, the second virtual scene is displayed on the graphical user interface, and an identity voting control is provided for each virtual object in the second virtual scene; in response to a voting operation for the identity voting control of a third virtual object in the second virtual scene, and a voting instruction corresponding to the voting operation is performed.

In the second virtual scene, each virtual object is provided with the identity voting control, and the user may operate the identity voting control of a certain virtual object to vote on the virtual object. The above third virtual object may be understood as a virtual object who is suspected by the user to have the target identity, and when the user performs the voting operation on the identity voting control of the third virtual object, the number of votes obtained by the third virtual object is increased by one. When the user corresponding to each virtual object in the second virtual scene performs the voting operation or performs the operation of abandoning the voting operation, the number of votes obtained by each virtual object in the second virtual scene may be counted, and a virtual object with the highest number of votes is set to be in the dead state, and no longer participates in the subsequent game process.

In a specific example, the target virtual object in the second virtual scene usually does not have an authority to send information and a voting operation authority for the identity voting control. However, the target virtual object may check the second virtual scene and information sent by other virtual objects in the second virtual scene.

The specific control manner for the temporary virtual object is described below. In response to a selection operation of the target virtual object in the second virtual object, the temporary virtual object is controlled to move from the initial position to the position where the target virtual object is located in the first virtual scene, and an attack operation is performed on the target virtual object. In actual implementation, a trigger control of temporary virtual objects may be displayed on the graphical user interface, such as a strike control in FIG. 3. After the trigger control is triggered, a display window may be generated, the second virtual object currently in the survival state is displayed in the display window, and the user may select one or a plurality of objects as the target virtual object. As shown in FIG. 5, the display window is displayed on the first virtual scene, virtual objects from No. 1 to No. 8 are displayed in the display window, and the user clicks on the virtual object No. 2 to display a confirmation control on the above display window. After the confirmation control is triggered, the virtual object No. 2 is determined as the target virtual object, and the system controls the temporary virtual object to start moving.

After performing the operation of confirming the attack, the user may control the temporary virtual object to move from the initial position to the position where the target virtual object is located in the first virtual scene, and then perform an attack on the target virtual object. After the user selects and determines the target virtual object, the system may automatically control the movement of the temporary virtual object, and then control the temporary virtual object to perform the attack operation on the target virtual object. In the above scenarios, the selection operation of the target virtual object may only include the selection operation for the target virtual object, or may include the selection operation for the target virtual object, and an attack confirmation operation for the target virtual object.

In a specific implementation, in response to the selection operation of the target virtual object in the second virtual object, a moving path of the temporary virtual object is generated according to the position where the target virtual object is located: the temporary virtual object is controlled to move along the moving path from the initial position until the temporary virtual object reaches the position where the target virtual object is located. It may be understood that the starting point of the moving path of the temporary virtual object is the initial position of the temporary virtual object, and the ending point is the position where the target virtual object is located. A route of the moving path may be determined according to a map route in the first virtual scene, if there are a plurality of optional routes, the route may be determined randomly, or the route may be selected based on a preset rule, e.g., selecting the longest or shortest route, selecting the route with the most or least number of virtual objects. In addition to the system determining the moving path of the temporary virtual object, the moving path may also be selected or set by the user. Specifically, the moving path of the temporary virtual object is generated in response to a path setting operation; where a destination of the moving path includes the position where the target virtual object is located. Specifically, the path setting operation may be drawing a path on a scene map, or may be a selection operation of a route position point, and the like.

In addition to attacking the target virtual object, the above temporary virtual object may also attack other virtual objects in the first virtual scene, thus increasing an attack capability of the temporary virtual object. Specifically, in response to that the temporary virtual object moves along the moving path, a minimum distance between the virtual object in the survival state and the temporary virtual object in the first virtual scene is determined; if there is a fourth virtual object with the minimum distance less than a specified distance in the virtual object in the survival state, it is determined that the fourth virtual object is attacked by the temporary virtual object. For example, the above specified distance may be set to zero or a very small value, when the temporary virtual object passes through the position where a certain virtual object is located, the virtual object may be used as the fourth virtual object and may be attacked by the temporary virtual object. The above specified distance may be set to a relatively great value, when the temporary virtual object moves along the moving path, each of the virtual object on the moving path and the virtual object near the moving path is attacked by the temporary virtual object. Specifically, a distance between the temporary virtual object and each virtual object is detected in real time during the movement of the temporary virtual object, if a certain distance value is less than or equal to the above specified distance, the virtual object corresponding to the distance value may be used as the fourth virtual object and attacked by the temporary virtual object.

The above temporary virtual object is triggered by the first virtual object with the target identity. On the graphical user interface corresponding to the first virtual object, the moving direction of the temporary virtual object is displayed in the first virtual scene in response to a movement of the temporary virtual object. For example, in the first virtual scene, the moving direction of the temporary virtual object may be indicated by an arrow, or the moving direction of the temporary virtual object may be identified in a scene graph. This manner may assist the user corresponding to the first virtual object to know the movement of the temporary virtual object.

In addition, first information is displayed in response to the selection operation of the target virtual object in the second virtual object; where the first information is set to indicate that the temporary virtual object starts moving. The first information is set to prompt the user that the temporary virtual object is triggered and will attack a certain target virtual object. The first information may be displayed on the graphical user interface corresponding to all virtual objects participating in the current match game.

After the temporary virtual object performs the attack operation on the target virtual object, the temporary virtual object is controlled to return to the initial position and the second information is displayed: where the second information is set to indicate that the temporary virtual object returns to the initial position. The second message is set to prompt the user that the temporary virtual object has been cancelled the attack operation. The second information may be displayed on the graphical user interface corresponding to all virtual objects participating in the current match game.

Since the temporary virtual object may assist the first virtual object with the target identity to attack other virtual objects, considering the fairness of the game, a certain trigger condition may be set for the temporary virtual object, and only if the trigger condition is met, the first virtual object may control the temporary virtual object to attack other virtual objects.

Specifically, in the initial state, the temporary virtual object is in a locked state, where in the locked state, the temporary virtual object is unable to be controlled to move from the initial position to the position where the target virtual object is located and to perform the specified operation on the target virtual object. That is, at this time, the temporary virtual object is in an uncontrollable state, and the first virtual object cannot attack other virtual objects through the temporary virtual object. In response to a current game state reaching a specified condition, the temporary virtual object is set to be in an unlocked state; where in the unlocked state, the temporary virtual object is able to be controlled to move from the initial position to the position where the target virtual object is located and to perform the specified operation on the target virtual object. In the unlocked state, the user corresponding to the first virtual object may decide whether to trigger the temporary virtual object to attack other virtual objects.

The above specified condition includes: a current game progress reaching a preset progress value, or a number of virtual objects in a dead state in a current game reaching a preset number. During the current match game is in progress, a progress bar of the game progress may be set to display a current game progress, and when the current game progress reaches the preset progress value, the temporary virtual object enters the unlocked state. During the current match game is in progress, the number of virtual objects in the current game that are in the dead state may be counted, specifically, it may count that a total number of virtual objects that are all currently in the dead state, or it may also count that a number of virtual objects with a specified identity that are in the dead state.

The above changes of game state may be adjusted according to the current real-time situation of the game. Specifically, among the plurality of virtual objects, the less a number of first virtual objects with the target identity, the faster a game state changes. For example, the less the number of first virtual objects with the target identity, the faster the game progress changes. When the number of the first virtual object is relatively small, a probability that the first virtual objects are all found out or are all in the dead state is relatively great. By improving a change speed of the game state, it is conducive to the temporary virtual object to enter the unlocked state as soon as possible, and the temporary virtual object is controlled by the first virtual object to attack other virtual objects, which is conducive to the reversal of the unfavorable game situation of the first virtual object and the improvement of the game score.

It may be seen from the above embodiments that, in the unlocked state, the temporary virtual object may be triggered by the first virtual object with the target identity. If there are a plurality of first virtual objects in the current game, each first virtual object may trigger the temporary virtual object, but the plurality of first virtual objects share the temporary virtual object, and the user corresponding to the first virtual object that triggers the temporary virtual object has the authority to select the target virtual object and control the temporary virtual object to attack the target virtual object.

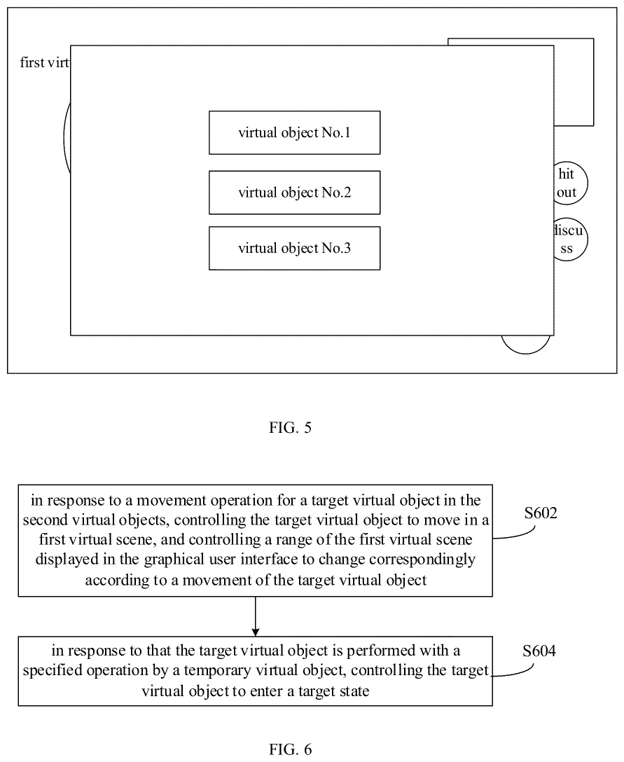

The following embodiment describes a method for attacking a target in a game from the perspective of the aforementioned target virtual object. A terminal device provides a graphical user interface, and the graphical user interface includes at least a part of the game scene, a first virtual object with a target identity and a plurality of second virtual objects in a survival state, the plurality of second virtual objects are other virtual objects in the same match with the first virtual object. As shown in FIG. 6, the method includes the following steps S602 and S604:
in step S602, in response to a movement operation for a target virtual object in the second virtual object, the target virtual object is controlled to move in a first virtual scene, and a range of the first virtual scene displayed in the graphical user interface is controlled to change correspondingly according to the movement of the target virtual object;

The first virtual scene is first provided in the graphical user interface, in the first virtual scene, the virtual object may move, perform a game task or perform other interactive operation. The user triggers a movement operation for the target virtual object to control the movement of the target virtual object in the first virtual scene, and a virtual camera in the first virtual scene moves following the movement of the target virtual object, which in turn causes the range of the first virtual scene displayed in the graphical user interface to change correspondingly according to the movement of the target virtual object.

The virtual objects participating in the current game match are in the same first virtual scene. Therefore, during the above movement of the target virtual object, if the target virtual object is closer to the other virtual objects, there may be other virtual objects entering into the range of the first virtual scene displayed in the graphical user interface, which are characters controlled by the other players.

In step S604, in response to that the target virtual object is performed with a specified operation by a temporary virtual object, the target virtual object is controlled to enter a target state;
where the temporary virtual object is a virtual object controlled by the first virtual object with the target identity; and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object;

In the above method for attacking the target in the game, in the first virtual scene, the first virtual object with the target identity may control the temporary virtual object to perform the specified operation on the target virtual object, without controlling the first virtual object to directly perform the specified operation on the target virtual object, and the attack manner is easy to operate, which may help the first virtual object to reduce a risk of exposing the target identity, and to improve the success rate of the attack.

In the second virtual scene, the above target virtual object does not have an authority to send information and a voting operation authority for the identity voting control.

In actual implementation, the above specified operation may be specifically an attack operation, and the target virtual object is controlled to enter the target state in response to that the target virtual object is performed with the attack operation by the temporary virtual object. The target state is a state of the target virtual object in the second virtual scene.

In addition, after the target virtual object is performed with the specified operation, there may be another processing manner for the target virtual object. For example, in response to that the target virtual object is performed with the specified operation by the temporary virtual object, the target object is controlled to be moved to a specified position in a third virtual scene; it is set that the target virtual object is restricted from using any operation within a specified time period. When the target virtual object is attacked, the third virtual scene is displayed in the graphical user interface corresponding to the target virtual object, and the target virtual object is located in the third virtual scene. The third virtual scene may be other virtual scene other than the above first virtual scene and the second virtual scene. In the third virtual scene, the target virtual object may be in a vertigo state for a specified time period, and cannot be moved or perform any other operation under the vertigo state.

Considering the balance of the game, when the temporary virtual object is triggered to start moving, the temporary virtual object is controlled to return to the initial position in response to that the plurality of second virtual objects in the survival state complete a specified operation; where if the temporary virtual object returns to the initial position, the temporary virtual object no longer has an authority to perform the specified operation on the target virtual object. The specified operation here may be a specified game task, and after the plurality of second virtual objects in the survival state complete the specified game task, the temporary virtual object may be controlled to return to the initial position before attacking the target virtual object, so as to avoid the target virtual object being attacked and improve odds of winning the game for the second virtual object that does not have the target identity.

It may be seen from the above embodiments that, before the target virtual object is performed with the specified operation by the temporary virtual object, the temporary virtual object is pre-moved from the initial position to the position where the target virtual object is located, in response to that the temporary virtual object starts moving, first information is displayed, where the first information is set to indicate that the temporary virtual object starts moving; and a display state of the game scene is adjusted. The first information is set to prompt the user that the temporary virtual object starts moving; and thus the user may control the second virtual object to complete the specified game task. In addition, in order to increase the experience effect of the game, a display state of the game scene is adjusted, for example, by reducing the brightness of the game scene, so as to narrow the field of view of the second virtual object; or for example, by flashing a red logo in the graphical user interface, so as to warn the relevant users that the temporary virtual object has departed.

A specific embodiment of a game match is provided below. As described in the above embodiments, there are usually two game stages in a game match: an action stage and a discussion stage. Based on these two game stages, this embodiment provides various functions in a game match as described below. In the action stage, there are usually functions one to eight. In the discussion stage, there are usually functions one, two and seven.

Function One: this embodiment provides a display function of a virtual map. In response to a movement operation on a first virtual object, the first virtual object is controlled to move in a first virtual scene, and a range of the first virtual scene displayed in a graphical user interface is controlled to correspondingly change according to the movement of the first virtual object; and in response to a preset trigger event, the virtual scene displayed in the graphical user interface is controlled to be switched from the first virtual scene to a second virtual scene, and the second virtual scene includes at least one second virtual object.

In this embodiment, the description is made from the perspective of a first virtual object with a target identity. The first virtual scene is first provided in the graphical user interface, as shown in FIG. 3, in which the virtual object may move, or perform a game task, or perform other interactive operation. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 3, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in a survival state. The plurality of second virtual objects in the survival state may refer to the virtual objects in the survival state other than the first virtual object in the current game match. Specifically, the user may determine the target virtual object based on the position, behavior, and the like of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the survival state. For example, in FIG. 3, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, and the like, of the virtual object.

In the second virtual scene, the virtual object in the survival state has the authority to speak, discuss and vote, but the target virtual object enters the target state, resulting in at least some of the interactions configured for the target virtual object in the second virtual scene being in a restricted state. The interactions may include speaking, discussing and voting interactions, and the like. The restricted state may be that a certain interaction is not allowed, or a certain interaction is not allowed within a certain period of time, or a certain interaction is limited to a specified number of times.

As shown in FIG. 4, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. The user may also click on an abstain button to give up the voting authority for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object. Specific implementations of the process may be referred to in the embodiments described above.

Function Two: this embodiment provides an information display function for a virtual object. A first virtual scene and a first virtual object located in the first virtual scene are displayed in a graphical user interface. In response to a movement operation for the first virtual object, the first virtual object is controlled to move in the first virtual scene, and a range of the first virtual scene displayed in the graphical user interface is controlled to correspondingly change according to the movement of the first virtual object. In response to a note addition operation, note prompt information is displayed for at least one second virtual object in the graphical user interface. In response to a trigger operation for the note prompt information, note information is added for a target virtual object among the displayed at least one second virtual object.

In this embodiment, the description is made from the perspective of the first virtual object with a target identity. The first virtual scene is first provided in the graphical user interface, as shown in FIG. 3, in which the virtual object may move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players, or non-player controlled virtual characters. As shown in FIG. 8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual object to enter the second virtual scene.

When the user controls the first virtual object to move in the first virtual scene, the user may determine the target virtual object from at least one second virtual object in a survival state, and/or at least one third virtual object in a dead state. The at least one second virtual object in the survival state may refer to the virtual object(s) in the survival state other than the first virtual object in the current game match. Specifically, the user may determine the target virtual object based on the position, the behavior, and the like of each of the second virtual objects. For example, the user selects a virtual object as the target virtual object that is relatively isolated and is not easily detected by other virtual objects upon attacking. The user may also select a virtual object as the target virtual object that has suspicious identity information reasoned based on the position, the behavior, and the like. After the target virtual object is determined, the e target virtual object may be controlled to move to the position of the target virtual object from an initial position in the first virtual scene, or the target virtual object may be selected, such that specified operations may be performed on the target virtual object, and then the target virtual object enters a target state.

For example, in response to a note addition operation, note prompt information is displayed for at least one second virtual object in the graphical user interface; and in response to a trigger operation for the note prompt information, note information is added for a target virtual object among the at least one second virtual object displayed. In this case, the note information may be displayed on the peripheral side of the target virtual object in the first virtual scene, that is, when the first virtual object is moved in the first virtual scene according to the movement operation and the range of the first virtual scene displayed in the graphical user interface is controlled to correspondingly change according to the movement of the first virtual object, if the target virtual object appears in a preset range of the first virtual object, the player may see the target virtual object as well as the note information of the target virtual object through the first virtual scene presented in the graphical user interface.

The second virtual scene is displayed in the graphical user interface upon the triggering of the preset trigger event. For example, the trigger event may be a specific trigger operation, which may be performed by any virtual object in the survival state. For example, in FIG. 4, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object, or its character model and character icon, in addition to the first virtual object, or its character model and object icon, where the character icon may be an avatar, a name, and the like, of the virtual object.

In the second virtual scene, the virtual object in the survival state has the authority to speak, discuss and vote, and if the target virtual object enters the target state (e.g., added with the note information), the current player may see the target virtual object and the note information of the target virtual object through the second virtual scene presented in the graphical user interface. In addition, the second virtual scene is also configured with interaction modes, which may include speaking and discussing interactions, voting interactions, note interactions, and the like. A state in which the use of the interaction mode is restricted may be that a certain interaction mode is not allowed, or a certain interaction mode is not allowed within a certain period of time, or a certain interaction mode is limited to a specified number of times. For example, a virtual character in a dead state is restricted from using the voting interaction, and a virtual character in a dead state whose identity is known is restricted from using the note interaction.

As shown in FIG. 4, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. The user may also click on an abstain button to give up the voting authority for this time. Additionally, a note control may be displayed along with the voting button to add note information to the clicked virtual object based on a touch operation for the note control.

In addition, a note list may also be displayed in the second virtual scene, and the note prompt information may be displayed in the note list in order to add note information to the displayed target virtual object in response to a trigger operation for the note prompt information. Specific implementations of the process may be referred to in the embodiments described above.

Function Three: this embodiment provides a control function of a game progress. In an action stage, at least part of a first virtual scene of the action stage and a first virtual object located in the first virtual scene are displayed in a graphical user interface. A skill configuration parameter of the first virtual object is obtained to determine an additional skill, newly added on the basis of a character default skill, of the first virtual object, and the default skill is a skill assigned according to an identity attribute of the first virtual object. When it is determined that a virtual task completion progress in a game stage has reached a progress threshold, the first virtual object is controlled to unlock the additional skill, and an additional skill control configured to trigger the additional skill is provided, on the basis of providing a default skill control configured to trigger the default skill in the graphical user interface. In response to a preset trigger event, the graphical user interface is controlled to display a second virtual scene corresponding to a discussion stage. The second virtual scene includes at least one of: a second virtual object, a character icon of the second virtual object, the first virtual object, and a character icon of the first virtual object. The discussion stage is configured to determine a game state of at least one second virtual object or the first virtual object based on a result of the discussion stage. Specific implementations of the process may be referred to in the embodiments described below.

In the embodiments of the present disclosure, the description is made from the perspective of the first virtual object with a first character attribute. A first virtual scene is first provided in the graphical user interface, as shown in FIG. 3, in which the first virtual object may move, or perform a game virtual task, or perform other interactive operations. The user triggers a movement operation for the target virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

When the user controls the first virtual object to move in the first virtual scene, the additional skill of the first virtual object newly added on the basis of the character default skill is determined based on the skill parameter of the first virtual object. The additional skill may include at least one of: an identity gambling skill, an identity verification skill, a guidance skill, and a task doubling skill. It is also determined the virtual task progress jointly completed by a plurality of other virtual objects having the same character attribute (the first character attribute) as the first virtual object in the current game stage, which is displayed based on the progress bar. When it is determined that the virtual task completion progress in the game stage has reached the progress threshold, the first virtual object may be controlled to unlock the additional skill, and the first virtual object utilizes the additional skill to play the game. For example, the guidance skill may be used to determine, during the action stage, the virtual object in the first virtual scene that is in a target state (e.g., dead, and the like) and within a preset distance threshold from the first virtual object, such that the first virtual object may be controlled to move to the position of the virtual object in the target state, and a discussion may be initiated immediately.

The second virtual scene is displayed in the graphical user interface upon the triggering of the preset trigger event. For example, the trigger event may be a specific trigger operation, which may be performed by any virtual object in the survival state. For example, in FIG. 4, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object and an object icon of the first virtual object, where the object icon may be an avatar, a name, and the like, of the virtual object.

In the second virtual scene, the virtual object in the survival state has the authority to speak, discuss and vote. As shown in FIG. 4, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. Before voting, the user may control the first virtual object to use the corresponding unlocked additional skill to check the virtual object of key suspicion. For example, the first virtual object may use the identity verification skill to check the identity of the virtual object of key suspicion, and based on the check result, determine whether to vote for the virtual object to improve the accuracy of the vote. Note that, the user may also click on an abstain button to give up the voting authority for this time.

Function Four: this embodiment provides another display function of a virtual map. In response to a movement operation, a virtual character is controlled to move in a virtual scene and the virtual scene to which the virtual character is currently moved is displayed in a graphical user interface. In response to a map display operation, a first virtual map corresponding to the virtual scene is superimposed on top of the virtual scene. In response to a map switching condition being triggered, the first virtual map superimposed on top of the virtual scene is switched to a second virtual map corresponding to the virtual scene. A transparency of at least part of a map area of the second virtual map is higher than a transparency of a map area corresponding to the first virtual map, such that a degree of occlusion of information in the virtual scene by the virtual map after the switching is lower than a degree of occlusion before the switching.

In this embodiment, the description is made from the perspective of a virtual object controlled by a player. A virtual scene is provided in the graphical user interface, as shown in FIG. 3. In this virtual scene (e.g., the first virtual scene as shown in FIG. 3), the virtual character (e.g., the first virtual character and/or the second virtual character as shown in FIG. 3) controlled by the player may move in the virtual scene, or perform a game task, or perform other interactive operations. In response to a movement operation triggered by the player, the virtual object is controlled to move in the virtual scene, and in most cases, the virtual object is located in a position at a relative center of a range of the virtual scene displayed in the graphical user interface. The virtual camera in the virtual scene follows the movement of the virtual object, which in turn causes the virtual scene displayed in the graphical user interface to change in correspondence to the movement of the virtual object, thus the virtual scene to which the virtual character is currently moved is displayed in the graphical user interface.

The virtual objects participating in the current game match are in the same virtual scene. Therefore, during the movement of the virtual object, if the virtual object is closer to the other virtual objects, there may be other virtual objects entering into the range of the virtual scene displayed in the graphical user interface, which are characters controlled by the other players. As shown in FIG. 3, there are a plurality of virtual objects displayed in the range of the virtual scene, in addition to which there is displayed in the graphical user interface a movement control for controlling the movement of the virtual object, a plurality of attack controls, and a discussion control. The discussion control may be configured to control the virtual objects to enter the second virtual scene as shown in FIG. 4.

In response to a map display operation triggered by the user, a first virtual map is displayed superimposed on top of the virtual scene displayed in the graphical user interface. For example, in response to a touch operation by the game player on a thumbnail of the scene (such as the scene map shown in FIG. 4), the first virtual map is displayed superimposed over the virtual scene. For example, in response to a control operation that controls the virtual character to perform a second specific action, the first virtual map is displayed superimposed over the virtual scene. Here, the first virtual map includes at least a current position of the first virtual character, a position of each first virtual area in the virtual scene, a position of a connected area, and the like.

When the map switching condition is triggered, the first virtual map superimposed on the virtual scene in the graphical user interface is switched to the second virtual map corresponding to the virtual scene, where at least a portion of the map area of the second virtual map has a higher transparency than the transparency of the map area corresponding to the first virtual map, such that the degree of occlusion of the information in the virtual scene by the switched virtual map is lower than the degree of occlusion before the switching. For example, the map switching condition may be a specific triggering operation, which may be performed by the virtual object in the survival state. For example, in response to a control operation controlling the virtual object to perform a first specific action, the first virtual map superimposed on the virtual scene is switched to the second virtual map corresponding to the virtual scene. For another example, the first virtual map superimposed on the virtual scene is switched to the second virtual map corresponding to the virtual scene by triggering a map switching button.

When the map switching condition is triggered, the first virtual map may be switched to the second virtual map by a specific switching method, which may be, for example, replacing the first virtual map superimposed on the virtual scene with the second virtual map corresponding to the virtual scene; or, adjusting the first virtual map to a state where the first virtual map is not visible in the current virtual scene in accordance with a first change threshold of transparency, and replacing the first virtual map superimposed on the virtual scene with the second virtual map corresponding to the virtual scene; or clearing the first virtual map superimposed on the virtual scene, and superimposing and displaying the second virtual map in the virtual scene in accordance with a second change threshold of transparency; or, in accordance with a third change threshold of transparency, adjusting the transparency of the first virtual map, and at the same time, in accordance with a fourth change threshold of transparency, superimposing and displaying the second virtual map on the virtual scene, until the first virtual map is in a state where the first virtual map is not visible in the current virtual scene.

Function Five: this embodiment provides a target attack function in a game. In response to a movement operation for a first virtual object, the first virtual object is controlled to move in a first virtual scene and a range of the first virtual scene displayed in a graphical user interface is controlled to change in accordance with the movement of the first virtual object. A temporary virtual object is controlled to move from an initial position to a position of a target virtual object in the first virtual scene and to perform a specified operation on the target virtual object, so as to make the target virtual object to enter a target state. The temporary virtual object is a virtual object controlled by the first virtual object with a target identity; and the target identity is an identity attribute assigned at the beginning of the match. The target virtual object is a virtual object determined from a plurality of second virtual objects in a survival state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its object icon.

In this embodiment, the description is made from the perspective of a first virtual object with a target identity. A first virtual scene is first provided in the graphical user interface, as shown in FIG. 3, in which the virtual object may move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIG. 3, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

The temporary virtual object is a virtual object controlled by the first virtual object with a target identity, and the target identity is an identity attribute assigned at the beginning of the match. The target virtual object is a virtual object determined from a plurality of second virtual objects in a survival state. The target state is a state where at least a portion of the interactions configured for the target virtual object in a second virtual scene are in a restricted state. The second virtual scene is a virtual scene displayed in the graphical user interface in response to a preset trigger event, and the second virtual scene includes at least one second virtual object or its character icon.

In an initial state, the temporary virtual object is not controlled by the user, but under certain specific conditions, the first virtual object with the target identity itself or the user corresponding to the first virtual object with the target identity has the authority to control the temporary virtual object. Specifically, the temporary virtual object may be controlled to move from an initial position to a position of the target virtual object in the first virtual scene, and to perform a specified operation on the target virtual object. The initial position may be a position where the temporary virtual object is located when it is not controlled. The specified operation may be an attack operation that produces, after the specified operation is performed on the target virtual object, a specific effect on the target virtual object. i.e., the above-described “make the target virtual object to enter a target state”.

When the user controls the first virtual object to move in the first virtual scene, the user may determine the target virtual object from a plurality of second virtual objects in a survival state. The plurality of second virtual objects in the survival state may refer to the virtual objects in the survival state other than the first virtual object in the current game match. Specifically, the user may determine the target virtual object based on the position, behavior, and the like of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the survival state. For example, in FIG. 3, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, and the like, of the virtual object.

In the second virtual scene, the virtual object in the survival state has the authority to speak, discuss and vote, but the target virtual object enters the target state, resulting in at least some of the interactions configured for the target virtual object in the second virtual scene being in a restricted state. The interactions may include speaking, discussing and voting interactions, and the like. The restricted state may be that a certain interaction is not allowed, or a certain interaction is not allowed within a certain period of time, or a certain interaction is limited to a specified number of times.

As shown in FIG. 4, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. The user may also click on an abstain button to give up the voting authority for this time.

In the above method for attacking the target in the game, in the first virtual scene, the first virtual object with the target identity may control the temporary virtual object to perform the specified operation on the target virtual object, without controlling the first virtual object to directly perform the specified operation on the target virtual object, and the attack method is easy to operate, which may help the first virtual object to reduce the risk of exposing the target identity; and to improve the success rate of the attack.

Function Six: this embodiment provides an interactive data processing function in a game. In response to a touch operation for a movement control area, a first virtual object is controlled to move in a virtual scene, and a range of the virtual scene displayed in a graphical user interface is controlled to change according to the movement of the first virtual object. It is determined that the first virtual object moves to a responsive area of a target virtual entity in the virtual scene, and the target virtual entity is provided in the virtual scene to be interacted with the virtual object. In response to a control instruction triggered by the touch operation, a display state of the first virtual object is controlled to switch to an invisible state and a marker for referring to the first virtual object is displayed in an area of the target virtual entity.

The movement control area is configured to control the movement of the virtual object in the virtual scene, and the movement control area may be a virtual joystick, through which a moving direction of the virtual object may be controlled, and a moving speed of the virtual object may also be controlled.

The virtual scene displayed in the graphical user interface is mainly obtained by taking images of a virtual scene range corresponding to the position of the virtual object through the virtual camera. During the movement of the virtual object, the virtual camera may usually be configured to follow the movement of the virtual object, in which case the range of the virtual scene taken by the virtual camera will also follow the movement.

Some virtual entities with interaction functions may be provided in the virtual scene, and the virtual entities may interact with the virtual objects. The interaction may be triggered when the virtual object is located in the responsive area of the virtual entity. At least one virtual entity having an interaction function may be included in the virtual scene, and the target virtual entity is any one of the at least one virtual entity having an interaction function.

The range of the responsive area of the virtual entity may be set in advance, for example, the range of the responsive area may be set according to the size of the virtual entity; or the range of the responsive area may be set according to the type of the virtual entity, which may be set according to the actual requirements. For example, the range of the responsive area of the virtual entity of a vehicle type may be set to be greater than the area where the virtual entity is located, and the range of the responsive area of the virtual entity of a prop type used for pranks may be set to be equal to the area where the virtual entity is located.

The touch operation, for triggering the control instruction, may be a specific operation for a specified area or a specific operation for a specified object. For example, the control instruction may be triggered by double clicking on the target virtual entity. For another example, an interactive control may be provided in the graphical user interface, and the control instruction may be triggered by clicking on the interactive control. The interactive control may be provided after it is determined that the first virtual object moves to the responsive area of the target virtual entity in the virtual scene. Based on this, the method may further include: controlling the graphical user interface to display the interactive control of the target virtual entity; and the control instruction triggered by the touch operation includes a control instruction triggered by touching the interactive control.

The embodiments of the present disclosure may realize that after a game player triggers an interaction with a virtual object, the display state of the virtual object may be controlled to switch to an invisible state, and the switching of the display state as well as the operation for switching will not affect the process of the game by themselves, which increases the interaction with the game player, improves the interestingness, and enhances the user experience.

In some embodiments, the target virtual entity may be a virtual vehicle, and the virtual vehicle may be preset with a preset threshold value, which is configured to indicate the maximum number of bearers of the virtual vehicle, that is, the maximum number of virtual objects that are invisible on the virtual vehicle. Based on this, if it is determined that the virtual vehicle is fully loaded, a player who subsequently performs an invisible switch may be instructed that the invisibility has failed.

In some embodiments, the reasoning game may include two sessions that may be divided into two parts, an action session and a voting session. In the action session, all virtual objects in the survival state (players in the game) may act, e.g., they may do tasks, they may mess up, and the like. In the voting session, players may gather to discuss and vote on the results of their reasoning, e.g., to reason about the identity of each virtual object, and the different identities of virtual objects may correspond to different tasks. In this type of game, a skill may also be released in the area of the target virtual entity to perform a task, or to cause a disturbance, and the like. Based on this, after it is determined that the first virtual object moves to the responsive area of the target virtual entity in the virtual scene, the method may further include: responding to a skill release instruction triggered by the touch operation, determining at least one virtual object that is invisible in the area of the target virtual entity as a candidate virtual object; and randomly determining one of the at least one candidate virtual object as the object on which the skill release instruction is to be acted upon.

The virtual object on which the skill release instruction triggered by the touch operation acts may be a character in the invisible state or a virtual object in the non-invisible state.

Function Seven: this embodiment provides a scene recording function in a game. A game interface is displayed on a graphical user interface, the game interface including at least part of a first virtual scene in a first game task stage, and a first virtual object located in the first virtual scene. In response to a movement operation for the first virtual object, a range of the virtual scene displayed in the game interface is controlled to change according to the movement operation. An image of a preset range of a current game interface is obtained in response to a record instruction triggered in the first game task stage. The image is stored. The image is displayed in response to a view instruction triggered in a second game task stage, and the second game task stage and the first game task stage are different task stages in a game match that the first virtual object is currently in.

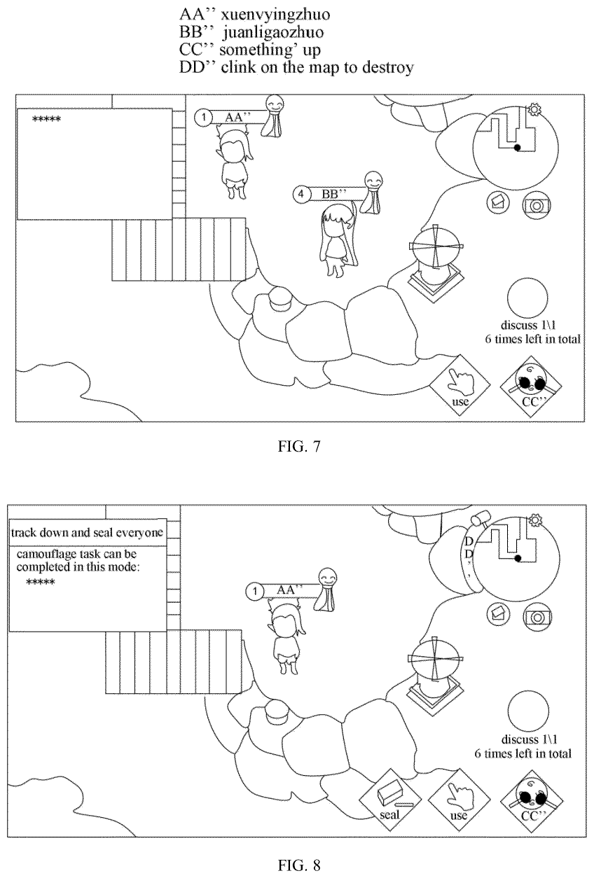

In this embodiment, the description is made from the perspective of a first virtual object with a target identity. A first virtual scene is first provided in the graphical user interface, as shown in FIGS. 7-8, in which the virtual object may move, or perform a game task, or perform other interactive operations. The user triggers a movement operation for the first virtual object to control the movement of the first virtual object in the first virtual scene, and in most cases, the first virtual object is located in a position at a relative center of a range of the first virtual scene displayed in the graphical user interface. The virtual camera in the first virtual scene moves following the movement of the first virtual object, which in turn causes the range of the first virtual scene displayed in the graphical user interface to change correspondingly according to the movement of the first virtual object.

The virtual objects participating in the current game match are in the same first virtual scene. Therefore, during the movement of the first virtual object, if the first virtual object is closer to the other virtual objects, there may be other virtual objects entering into the range of the first virtual scene displayed in the graphical user interface, which are characters controlled by the other players. As shown in FIGS. 7-8, there are two nearby second virtual objects displayed in the range of the first virtual scene, in addition to which there is displayed in the graphical user interface a movement control for controlling the movement of the first virtual object, a plurality of attack controls, and a discussion control. The discussion control may be configured to control the virtual objects to enter the second virtual scene.

When the user controls the first virtual object to move in the first virtual scene, the user may determine the target virtual object from a plurality of second virtual objects in a survival state. The plurality of second virtual objects in the survival state may refer to the virtual objects in the survival state other than the first virtual object in the current game match. Specifically, the user may determine the target virtual object based on the position, behavior, and the like of each of the second virtual objects. For example, the user selects a virtual object as the target virtual object that is relatively isolated and is not easily detected by other virtual objects when attacking. After the target virtual object is determined, it may be controlled to move in the first virtual scene to the position of the target virtual object from an initial position, and a specified operation may be performed on the target virtual object, and then the target virtual object enters a target state.

The second virtual scene is displayed in the graphical user interface upon the triggering of the preset trigger event. For example, the trigger event may be a specific trigger operation, which may be performed by any virtual object in the survival state. For example, as shown in FIGS. 7-8, the second virtual scene may be displayed in the graphical user interface by triggering the discussion control, thereby achieving that the virtual scene is switched from the first virtual scene to the second virtual scene, and all virtual objects in the current game match are moved from the first virtual scene to the second virtual scene. The second virtual scene includes at least one second virtual object or its object icon in addition to the first virtual object or an object icon of the first virtual object, where the object icon may be an avatar, a name, and the like, of the virtual object.

In the second virtual scene, the virtual object in the survival state has the authority to speak, discuss and vote, but the target virtual object enters the target state, resulting in at least some of the interactions configured for the target virtual object in the second virtual scene being in a restricted state. The interactions may include speaking, discussing and voting interactions, and the like. The restricted state may be that a certain interaction is not allowed, or a certain interaction is not allowed within a certain period of time, or a certain interaction is limited to a specified number of times.

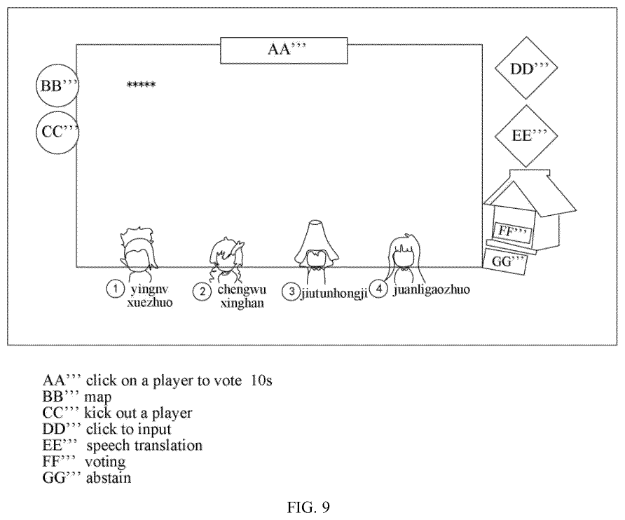

As shown in FIG. 9, the second virtual scene includes a plurality of virtual objects in the survival state, including the first virtual object. The first virtual object may send a discussion message through a “Click to Input” control and a “Speech Translation” control on the right side. The discussion message sent by the virtual object may be displayed on a discussion message panel, and the discussion message may include who initiates the discussion, who is attacked, the position of the virtual object that is attacked, and the position of each virtual object upon the initiation of the discussion, and the like.

The user may vote for a virtual object by clicking on the virtual object in the second virtual scene to display a voting button for the virtual object in the vicinity of the virtual object. The user may also click on an abstain button to give up the voting authority for this time.

In response to a touch operation for a function control, a position marking interface is displayed in the graphical user interface, and in the position marking interface, a character identifier of the at least one second virtual object and/or the first virtual object is displayed based on the position marking information reported by the at least one second virtual object and/or the first virtual object.

Function Eight: this embodiment provides a game operation function. A graphical user interface is provided via a terminal, the graphical user interface includes a virtual scene and a virtual object, the virtual scene includes a plurality of transport areas, and the plurality of transport areas include a first transport area and at least one second transport area at a different position in the scene corresponding to the first transport area. In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the virtual scene displayed in the graphical user interface that includes the first transport area is controlled to change to a virtual scene that includes the second transport area corresponding to the target directional control.

In response to a touch operation directed to a movement control area, the virtual object is controlled to move in the virtual scene. It is determined that the virtual object moves to the first transport area, and a first set of directional controls, corresponding to the at least one second transport area, is displayed in the movement control area. In response to a trigger instruction directed to a target directional control among the first set of directional controls, the range of the virtual scene displayed in the graphical user interface that includes the first transport area is controlled to change to a range of a virtual scene that includes the second transport area corresponding to the target directional control.

In this embodiment, the graphical user interface includes at least a portion of a virtual scene and a virtual object. The virtual scene includes a plurality of transport areas, and the plurality of transport areas include a first transport area and at least one second transport area at a different position in the scene corresponding to the first transport area. The first transport area may be an entrance area of a hidden area (e.g., a tunnel, a subway, and the like, the tunnel being used as an example in the present disclosure). The second transport area may be an exit area of the hidden area.

The graphical user interface may include a movement control area, and the position of the movement control area in the graphical user interface may be customized based on actual requirements, for example, it may be set in the lower left, lower right, and other thumb-touchable areas of the graphical user interface for the game player.

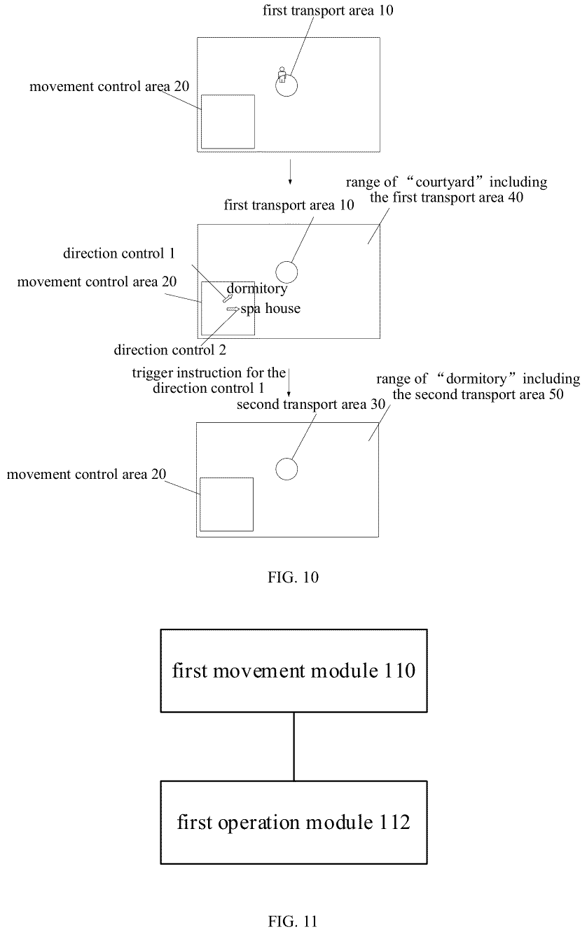

As shown in FIG. 10, a user inputs a touch operation directed to a movement control area to control movement of a virtual object in a virtual scene, and if it is determined that the virtual object moves to a first transport area, a first set of directional controls (directional control 1 and directional control 2) corresponding to at least one second transport area is displayed in the movement control area. The first set of directional controls is configured to indicate the direction of the corresponding tunnel exit.

The user inputs a trigger instruction for the target directional control (directional control 1) of the first set of directional controls to change a range of the virtual scene displayed in the graphical user interface that includes the first transport area to a range of the virtual scene that includes the second transport area corresponding to the target directional control. That is, through the trigger instruction for the target directional control, the current display in the graphical user interface is made to be the range of the virtual scene of the second transport area corresponding to the directional control 1. The specific implementation of the process may be referred to in the above embodiments.

Corresponding to the above method embodiment, referring to a structure diagram of an apparatus for attacking a target in a game shown in FIG. 11, a graphical user interface is provided through a terminal device; the graphical user interface includes at least a part of the game scene, a first virtual object with a target identity and a plurality of second virtual objects in a survival state, the plurality of second virtual objects are other virtual objects in the same match with the first virtual object, and the apparatus includes:
a first movement module 110, configured to, in response to a movement operation for the first virtual object, control the first virtual object to move in a first virtual scene, and control a range of the first virtual scene displayed in the graphical user interface to change correspondingly according to a movement of the first virtual object;
a first operation module 112, configured to control a temporary virtual object in the first virtual scene to move from an initial position to a position where a target virtual object is located and to perform a specified operation on the target virtual object, such that the target virtual object enters a target state, where the temporary virtual object is a virtual object controlled by the first virtual object with the target identity, and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object.

The apparatus also includes: a voting module, configured to, in response to the preset trigger event, display the second virtual scene on the graphical user interface, and provide an identity voting control for each virtual object in the second virtual scene; and in response to a voting operation for the identity voting control of a third virtual object in the second virtual scene, perform a voting instruction corresponding to the voting operation.

In the second virtual scene, the target virtual object does not have an authority to send information and a voting operation authority for the identity voting control.

The first operation module is also configured to, in response to a selection operation of the target virtual object in the second virtual object, control the temporary virtual object in the first virtual scene to move from the initial position to the position where the target virtual object is located, and perform an attack operation on the target virtual object.

The first operation module is also configured to, in response to the selection operation of the target virtual object in the second virtual object, generate a moving path of the temporary virtual object according to the position where the target virtual object is located; control the temporary virtual object to move along the moving path from the initial position until the temporary virtual object reaches the position where the target virtual object is located.

The first operation module is also configured to: in response to a path setting operation, generate the moving path of the temporary virtual object; where a destination of the moving path includes: the position where the target virtual object is located.

The apparatus also includes: a first attack module, configured to, in response to that the temporary virtual object moves along the moving path, determine a minimum distance between the virtual object in the survival state and the temporary virtual object in the first virtual scene; if there is a fourth virtual object with the minimum distance less than a specified distance in the virtual object in the survival state, determine that the fourth virtual object is attacked by the temporary virtual object.

The apparatus also includes: a first display module, configured to, in response to a movement of the temporary virtual object, display a moving direction of the temporary virtual object in the first virtual scene.

The apparatus also includes: a second display module, configured to, in response to the selection operation of the target virtual object in the second virtual object, display first information; where the first information is set to indicate that the temporary virtual object starts moving.

The apparatus also includes a third display module, configured to, control the temporary virtual object to return to the initial position and displaying second information; where the second information is set to indicate that the temporary virtual object returns to the initial position.

The apparatus also includes: a state setting module, configured that, in the initial state, the temporary virtual object is in a locked state, where in the locked state, the temporary virtual object is unable to be controlled to move from the initial position to the position where the target virtual object is located and to perform the specified operation on the target virtual object; and configured to, in response to a current game state reaching a specified condition, set the temporary virtual object to be in an unlocked state; where in the unlocked state, the temporary virtual object is able to be controlled to move from the initial position to the position where the target virtual object is located and to perform the specified operation on the target virtual object.

The specified condition includes: a current game progress reaching a preset progress value, or a number of virtual objects in a dead state in a current game reaching a preset number.

Among the plurality of virtual objects, the less a number of the first virtual objects with the target identity, the faster a game state changes.

In the unlocked state, the temporary virtual object is able to be triggered by the first virtual object with the target identity.

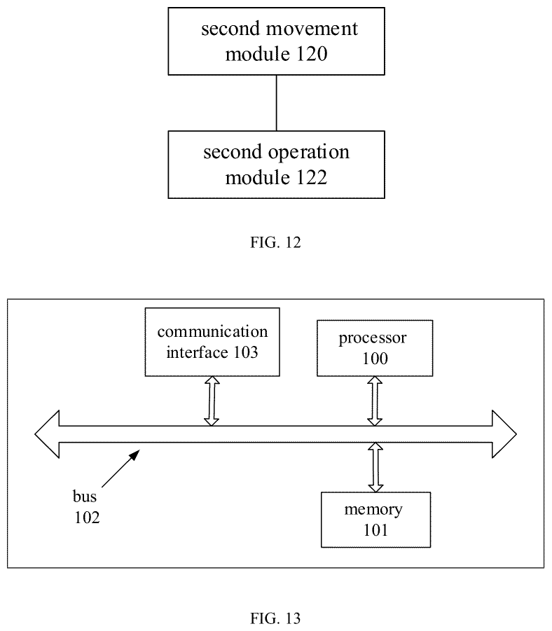

Referring to a structure diagram of another apparatus for attacking a target in a game shown in FIG. 12, and a graphical user interface is provided through a terminal device; the graphical user interface includes at least a part of a game scene, a first virtual object with a target identity and a plurality of second virtual objects in a survival state, the plurality of second virtual objects are other virtual objects in the same game with the first virtual object, and the apparatus includes:
a second movement module 120, configured to, in response to a movement operation for a target virtual object in the second virtual objects, control the target virtual object to move in a first virtual scene, and control a range of the first virtual scene displayed in the graphical user interface to change correspondingly according to a movement of the target virtual object;
a second operation module 122, configured to, in response to that the target virtual object is performed with a specified operation by a temporary virtual object, control the target virtual object to enter a target state; where the temporary virtual object is a virtual object controlled by the first virtual object with the target identity, and the target identity is an identity attribute assigned at the beginning of the match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, where the second virtual scene includes at least one second virtual object or an object icon of the second virtual object.

In the second virtual scene, the target virtual object does not have an authority to send information and a voting operation authority for the identity voting control.

The second operation module is also configured to, in response to that the target virtual object is performed with an attack operation by the temporary virtual object, control the target virtual object to enter the target state.

The apparatus also includes a third movement module, configured to, in response to that the target virtual object is performed with the specified operation by the temporary virtual object, control the target object to be moved to a specified position in a third virtual scene; and set that the target virtual object is restricted from using any operation within a specified time period.

The apparatus also includes a fourth movement module, configured to, in response to that the plurality of second virtual objects in the survival state complete a specified operation, control the temporary virtual object to return to the initial position, where if the temporary virtual object returns to the initial position, the temporary virtual object no longer has an authority to perform the specified operation on the target virtual object.

Before the target virtual object is performed with the specified operation by the temporary virtual object, the temporary virtual object is pre-moved from the initial position to the position where the target virtual object is located: the apparatus also includes a fourth display module, configured to, in response to that the temporary virtual object starts moving, display first information, where the first information is set to indicate that the temporary virtual object starts moving; and adjust a display state of the game scene.

The present embodiment further provides an electronic device, including a processor and a memory, where the memory stores with a machine-executable instruction that may be executed by the processor, and the processor executes the machine-executable instruction to implement the above-mentioned method for attacking the target in the game. The electronic device may be a server or a terminal device.

Referring to FIG. 13, the electronic device includes a processor 100 and a memory 101, the memory 101 stores with a machine-executable instruction that may be executed by the processor 100, and the processor 100 executes the machine-executable instruction to implement the method for attacking the target in the game.

Further, the electronic device shown in FIG. 13 further includes a bus 102 and a communication interface 103. The processor 100, the communication interface 103, and the memory 101 are connected through the bus 102.

The memory 101 may include a high-speed random-access memory (RAM), or may further include a non-volatile memory, such as at least one magnetic disk memory. The communication connection between the system network element and at least one other network element may be implemented by means of the at least one communication interface 103 (which may be wired or wireless), and the Internet, a wide area network, a local network, a metropolitan area network, etc. may be used. The bus 102 may be an ISA bus, a PCI bus, or an EISA bus, or the like. The bus may be divided into an address bus, a data bus, a control bus, and the like. For ease of representation, one bidirectional arrow is used in FIG. 13 to represent, but does not mean that there is one bus or one type of bus.

The processor 100 may be an integrated circuit chip having a signal processing capability. In an implementation process, the steps of the foregoing method may be completed by an integrated logic circuit of hardware in the processor 100 or an instruction in the form of software. The processor 100 may be a general processing unit, including a central processing unit (CPU), a network processor (NP), or the like, or may be a digital signal processor (DSP), an Application Specific Integrated Circuit (ASIC), a Field-Programmable Gate Array (FPGA) or another programmable logic device, a discrete gate or a transistor logic device, and a discrete hardware component. The methods, steps, and logic block diagrams disclosed in the embodiments of the present disclosure may be implemented or performed. The general processing unit may be a microprocessor or the processor may be any conventional processor or the like. The steps of the method disclosed in connection with the embodiments of the present disclosure may be directly embodied as a hardware decoding processor for implementation, or implemented by combining hardware in a decoding processor and a software module. The software module may be located in a mature storage medium in the art, such as a random-access memory; a flash memory, a read-only memory, a programmable read-only memory or an electrically erasable programmable memory, a register, etc. The storage medium is located in the memory 101, and the processor 100 reads the information in the memory 101 and completes the steps of the method according to the foregoing embodiments in combination with hardware of the processor 100.

The present embodiment further provides a machine-readable storage medium, where the machine-readable storage medium stores with a machine-executable instruction, and when the machine-executable instruction is invoked and executed by the processor, the machine-executable instruction enables the processor to implement the above-mentioned method for attacking the target in a game.

The computer program product of the method and apparatus for attacking the target in the game, an electronic device, and a storage medium provided in the embodiments of the present disclosure includes a computer-readable storage medium storing with a program code, where the instruction included in the program code may be used for executing the method described in the foregoing method embodiments. For specific implementations, reference may be made to the method embodiments, and details are not described here again.

It may be clearly understood by those skilled in the art that, for the convenience and brevity of description, the specific working process of the system and device described above may refer to the corresponding processes in the foregoing method embodiments, and details are not described here again.

In addition, in the description of the embodiments of the present disclosure, unless otherwise specified and restricted, the terms “mounting”. “connected” and “connecting” shall be construed broadly, for example, may be a fixed connection, a detachable connection, or an integrated connection; it may be a mechanical connection or an electrical connection; it may be directly connected or indirectly connected by an intermediate medium, and may be a communication between two elements. For those skilled in the art, the specific meaning of the above terms in the present disclosure may be understood specifically.

When the functions are implemented in the form of a software functional unit and sold or used as an independent product, it may be stored in a computer-readable storage medium. Based on such understanding, the technical solution of the present disclosure or the part contributing to the related art or the part of the technical solution may be embodied in the form of a software product in essence, and the computer software product is stored in a storage medium, and includes several instructions for enabling a computer device (which may be a personal computer, a server, or a network device, etc.) to perform all or part of the steps of the method according to various embodiments of the present disclosure. The foregoing storage medium includes various media that may store program codes, such as a USB flash disk, a mobile hard disk, a read-only memory (ROM), a random access memory (RAM), a magnetic disk, or an optical disc.

In the description of the present disclosure, it should be noted that the orientation or positional relationship indicated by the terms “center,” “upper,” “lower,” “left,” “right,” “vertical,” “horizontal,” “inner,” “outer,” and the like is based on the orientation or positional relationship shown in the drawings, just for the convenience of describing the disclosure and simplifying the description, rather than indicating or implying that the indicated device or element must have a specific orientation, constructed and operated in a specific orientation, and therefore cannot be understood as a limitation to the present disclosure. In addition, the terms “first”, “second” and “third” are used for descriptive purposes and cannot be understood as indicating or implying relative importance.

Finally, it should be noted that: the above embodiments are merely specific embodiments of the present disclosure for illustrating the technical solutions of the present disclosure without limitation, and the scope of protection of the present disclosure is not limited to this. Although the present disclosure is described in detail with reference to the foregoing embodiments. Those skilled in the art should understand that: any person skilled in the art may still modify or easily conceive of modifying the technical solutions recited in the foregoing embodiments, or equivalently replace some of the technical features in the technical scope disclosed in the present disclosure, and these modifications, changes or substitutions do not make the nature of the corresponding technical solutions depart from the spirit and scope of the technical solutions of the embodiments of the present disclosure, all of which should be covered within the scope of protection of the present disclosure. Therefore, the protection scope of the present disclosure shall be subject to the protection scope of the claims.

1. A method for attacking a target in a game, comprising:
providing, by a terminal device, a graphical user interface; wherein the graphical user interface comprises at least a part of a game scene, a first virtual object with a target identity and a plurality of second virtual objects in a survival state, the plurality of second virtual objects are other virtual objects in a same match with the first virtual object;
in response to a movement operation for the first virtual object, controlling the first virtual object to move in a first virtual scene, and controlling a range of the first virtual scene displayed in the graphical user interface to change correspondingly according to a movement of the first virtual object; and
controlling a temporary virtual object in the first virtual scene to move from an initial position to a position where a target virtual object is located and to perform a specified operation on the target virtual object, such that the target virtual object enters a target state, wherein the temporary virtual object is a virtual object controlled by the first virtual object with the target identity, and the target identity is an identity attribute assigned at a beginning of a match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, wherein the second virtual scene comprises at least one second virtual object or an object icon of the second virtual object.

2. The method according to claim 1, further comprising:
in response to the preset trigger event, displaying the second virtual scene on the graphical user interface, and providing an identity voting control for each virtual object in the second virtual scene; and
in response to a voting operation for an identity voting control of a third virtual object in the second virtual scene, performing a voting instruction corresponding to the voting operation.

3. The method according to claim 2, wherein in the second virtual scene, the target virtual object does not have an authority to send information and a voting operation authority for the identity voting control.

4. The method according to claim 1, wherein the step of controlling the temporary virtual object in the first virtual scene to move from the initial position to the position where the target virtual object is located and to perform the specified operation on the target virtual object comprises:
in response to a selection operation of the target virtual object in the second virtual object, controlling the temporary virtual object in the first virtual scene to move from the initial position to the position where the target virtual object is located, and performing an attack operation on the target virtual object.

5. The method according to claim 4, wherein the step of in response to the selection operation of the target virtual object in the second virtual object, controlling the temporary virtual object in the first virtual scene to move from the initial position to the position where the target virtual object is located comprises:
in response to the selection operation of the target virtual object in the second virtual object, generating a moving path of the temporary virtual object according to the position where the target virtual object is located;
controlling the temporary virtual object to move along the moving path from the initial position until the temporary virtual object reaches the position where the target virtual object is located.

6. The method according to claim 5, wherein the step of generating the moving path of the temporary virtual object according to the position where the target virtual object is located comprises:
in response to a path setting operation, generating the moving path of the temporary virtual object; wherein a destination of the moving path comprises: the position where the target virtual object is located.

7. The method according to claim 5, further comprising:
in response to that the temporary virtual object moves along the moving path, determining a minimum distance between the virtual object in the survival state and the temporary virtual object in the first virtual scene;
in case that there is a fourth virtual object with the minimum distance less than a specified distance in the virtual object in the survival state, determining that the fourth virtual object is attacked by the temporary virtual object.

8. The method according to claim 4, further comprising:
in response to a movement of the temporary virtual object, displaying a moving direction of the temporary virtual object in the first virtual scene.

9. The method according to claim 4, further comprising:
in response to the selection operation of the target virtual object in the second virtual object, displaying first information; wherein the first information is set to indicate that the temporary virtual object starts moving.

10. The method according to claim 4, further comprising:
controlling the temporary virtual object to return to the initial position and displaying second information; wherein the second information is set to indicate that the temporary virtual object returns to the initial position.

11. The method according to claim 1, further comprising:
in the initial state, the temporary virtual object being in a locked state, wherein in the locked state, the temporary virtual object is unable to be controlled to move from the initial position to the position where the target virtual object is located and to perform the specified operation on the target virtual object;
in response to a current game state reaching a specified condition, setting the temporary virtual object to be in an unlocked state; wherein in the unlocked state, the temporary virtual object is able to be controlled to move from the initial position to the position where the target virtual object is located and to perform the specified operation on the target virtual object.

12. The method according to claim 11, wherein the specified condition comprises: a current game progress reaching a preset progress value, or a number of virtual objects in a dead state in a current game reaching a preset number.

13. The method according to claim 11, wherein among the plurality of virtual objects, the less a number of the first virtual objects with the target identity, the faster a game state changes.

14. The method according to claim 11, wherein in the unlocked state, the temporary virtual object is able to be triggered by the first virtual object with the target identity.

15. A method for attacking a target in a game, comprising:
providing a graphical user interface by a terminal device;
wherein the graphical user interface comprises at least a part of a game scene, a first virtual object with a target identity and a plurality of second virtual objects in a survival state, the plurality of second virtual objects are other virtual objects in a same match with the first virtual object;
in response to a movement operation for a target virtual object in the second virtual objects, controlling the target virtual object to move in a first virtual scene, and controlling a range of the first virtual scene displayed in the graphical user interface to change correspondingly according to a movement of the target virtual object;
in response to that the target virtual object is performed with a specified operation by a temporary virtual object, controlling the target virtual object to enter a target state; wherein the temporary virtual object is a virtual object controlled by the first virtual object with the target identity, and the target identity is an identity attribute assigned at a beginning of a match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, wherein the second virtual scene comprises at least one second virtual object or an object icon of the second virtual object.

16. (canceled)

17. The method according to claim 15, wherein the step of controlling the target virtual object to enter the target state in response to that the target virtual object is performed with the specified operation by the temporary virtual object comprises:
in response to that the target virtual object is performed with an attack operation by the temporary virtual object, controlling the target virtual object to enter the target state.

18. The method according to claim 15, further comprising:
in response to that the target virtual object is performed with the specified operation by the temporary virtual object, controlling the target object to be moved to a specified position in a third virtual scene; and
setting that the target virtual object is restricted from using any operation within a specified time period.

19. The method according to claim 15, further comprising:
in response to that the plurality of second virtual objects in the survival state complete a specified operation, controlling the temporary virtual object to return to the initial position, wherein if the temporary virtual object returns to the initial position, the temporary virtual object no longer has an authority to perform the specified operation on the target virtual object.

20. The method according to claim 15, wherein before the target virtual object is performed with the specified operation by the temporary virtual object, the temporary virtual object is pre-moved from the initial position to the position where the target virtual object is located:
the method further comprises:
in response to that the temporary virtual object starts moving, displaying first information, wherein the first information is set to indicate that the temporary virtual object starts moving; and
adjusting a display state of the game scene.

21. An electronic device, comprising a processor and a memory,
wherein the memory stores with a machine-executable instruction capable of being executed by the processor, and the processor executes the machine-executable instruction to implement a method for attacking a target in a game, and the method comprises:
providing a graphical user interface; wherein the graphical user interface comprises at least a part of a game scene, a first virtual object with a target identity and a plurality of second virtual objects in a survival state, the plurality of second virtual objects are other virtual objects in a same match with the first virtual object, and the method comprises:
in response to a movement operation for the first virtual object, controlling the first virtual object to move in a first virtual scene, and controlling a range of the first virtual scene displayed in the graphical user interface to change correspondingly according to a movement of the first virtual object; and
controlling a temporary virtual object in the first virtual scene to move from an initial position to a position where a target virtual object is located and to perform a specified operation on the target virtual object, such that the target virtual object enters a target state, wherein the temporary virtual object is a virtual object controlled by the first virtual object with the target identity, and the target identity is an identity attribute assigned at a beginning of a match, the target virtual object is a virtual object determined from the plurality of second virtual objects in the survival state, the target state is a state where at least a portion of interactions configured for the target virtual object in a second virtual scene are in a restricted state, and the second virtual scene is a virtual scene displayed in the graphical user interface in response to a preset trigger event, wherein the second virtual scene comprises at least one second virtual object or an object icon of the second virtual object.

22. (canceled)
